(19) United States
(12) Patent Application Publication
(10) Pub. No.: US 2008/0115159 A1
(43) Pub. Date: May 15, 2008

(54) Optical Medium Clamping

(76) Inventors: Al Fetouhi, Nanteuil-les-Meaux (FR); Roger Nute, Chigne (FR)

Correspondence Address: FISH & RICHARDSON P.C., PO BOX 1022, MINNEAPOLIS, MN, 55440-1022, US

(21) Appl. No.: 11/686,607

(22) Filed: Mar. 15, 2007

(30) Foreign Application Priority Data
Nov. 15, 2006 (EP) 06 023 768.2

(51) Int. Cl. G11B 7/24

(52) U.S. Cl. 720/723

(57) ABSTRACT

An optical recording medium is described. The optical recording medium includes a substrate and a recording layer arranged on one side of the substrate. The optical recording medium has a predetermined clamping area. The clamping area is formed such as to achieve a deformation of or a tension in at least a part of the optical recording medium when it is clamped within a recording and/or reproducing device.

### RELATED APPLICATIONS

This application claims priority to European Patent Convention application having the patent application number 06023768.2, filed Nov. 15, 2006, the entirety of which is incorporated herewithin.

### TECHNICAL FIELD

The present invention relates to a recording medium, in particular to an optical recording medium including a substrate and a signal recording layer provided on the substrate.

### BACKGROUND

As one of the conventional recording media for audio, video and/or other information, optical discs such as CDs and DVDs, from which recorded information is read using a light beam or to which information is written using a light beam, are widely used. Since such an optical disc is formed from a single plate-like substrate, it can easily be handled and has a larger storage capacity than other recording media such as magnetic tapes, etc. Therefore, the optical discs are widely used as media for recording audio and video information, computer-processed data, etc. Recording media for audio, video and/or other information, such as CDs and DVDs are e.g. known from U.S. Pat. No. 5,541,910, U.S. Pat. No. 5,864,534, U.S. Pat. No. 6,002,663, U.S. Pat. No. 6,252,842 and US 2004/00434154 A1.

Information processing units, such as computers, CD/DVD players, digital cameras and video cameras, have been designed more and more compact with an increasingly smaller internal space of installation for a recording and/or reproducing apparatus using an optical recording medium such as an optical disc or the like. Accordingly, optical discs are also known in the prior art, e.g. from US 2004/0228263 A1, which only have a diameter of 65 mm or less.

US 2004/0228263 A1 discloses an optical disc having a thickness of only 0.4 mm to 0.7 mm, i.e. significantly thinner than conventional optical discs which have a thickness of about 1.2 mm. Such optical discs are also called light weight optical discs (LODs) or thin video discs (TVDs). With this measure it is achieved to reduce the amount of material which is necessary for manufacturing an optical disc and thus to significantly reduce the manufacturing costs. However, in the area around the axis of the optical disc described in US 2004/0228263 A1—the so called clamping area—, the substrate has a thickness of 1.2 mm, because this distance is prescribed for conventional recording and/or reproducing devices (e.g. drives for computers or CD/DVD players).

At present, a disc must meet the requirements of the “standard physical product” as defined in the Red Book standard, particularly in terms of deflection of the beam incident to the surface of the reflective plan and thus consistency of performance of the disc for the end user. The optical disc disclosed in US 2004/0228263 A1 has the drawback that in many cases the shape of the recording area is not within the prescribed tolerances. As a result, this optical disc is not a reliable recording medium for all types of disc cartridges e.g. for computers, CD/DVD players, digital cameras and video cameras, in particular because the disc cartridges of the various manufacturers are not completely standardized.

### SUMMARY

It is an object of the present invention to provide a novel light weight optical recording medium which has an increased reliability. Problems relating to playability should be reduced or avoided.

This object is achieved by an optical recording medium as defined in claims 1, 2, 8, 9, 13 and 14. The dependent claims depict advantageous embodiments of the invention.

The present invention is directed to an optical recording medium comprising a substrate and at least one recording layer for storing data, wherein the structure of the recording layer is formed such that the data can be read using a light having a wavelength of 650 nm±50 nm. Such a wavelength is used for reading DVDs, whereas CDs can only be read with a wavelength of 780 nm. From a structural point of view, the structure of the recording layer has pits and lands with a height difference of 650 nm/4±10%. Due to the reflection at the pits and lands, there is a phase difference of λ/2 which results in interference effects so that the photo detectors of the reading device can read the optical recording medium.

The present invention can be defined in various ways wherein all definitions are linked by the same inventive concept:

According to one aspect of the present invention, the recording layer is at least partially or entirely positioned at a distance T₇ of less than 0.4 mm with respect to the second surface. In particular, the recording layer may be positioned at a distance T₇ of less than 0.3 mm with respect to the second surface. The (upper) second surface is usually covered by a printing layer so that the optical recording medium is designed to be read with a laser which is positioned on the side of the (lower) first surface of the optical recording medium. With that, the optical recording medium of the present invention is a DVD has the layer structure like a known CD as will be explained in more detail in context with FIGS. 1 to 7. The inventive DVD thus has a recording layer which is very closely positioned to the (upper) second surface, whereas the recording layer of known DVDs is in the middle of recording medium (sandwiched between to discs of polycarbonate). Therefore, when the optical recording medium of the present invention is clamped in a drive, the recording layer has a “higher” position than a recording layer of a known DVD.

Providing a DVD having a layer structure of a CD is not yet known in the prior art. In particular, many DVD drives are only designed to read DVDs having a recording layer in the middle of the disc. However, the inventive recording medium can be read with a drive which is suitable for reading DVDs and CDs, because such drives have a height adjustable reading means. As a result, the layer structure of the inventive optical recording medium is a key feature of reducing the thickness of the disc in an area of the recording layer. In particular, a thickness T₁ of only 0.4 to 0.7 mm is possible (see FIG. 7) while remaining the reliability of the optical recording medium (i.e. without reading problems in most or all drives). Further, it is achieved that the optical recording medium may have only one substrate, i.e. only one discs of polycarbonate, whereas the other side of the recording layer is only covered by a protective lacquer. With that, manufacturing of the inventive optical recording medium is facilitated and more cost-efficient.

According to a second aspect of the present invention, the recording layer is at least partially positioned at a distance T₅ of more than 0.9 mm from a plane defined by a surface of a clamping area of the optical recording medium. The clamping area preferably defines the maximum thickness T₂ of the optical recording medium, wherein there is a height difference between lowest surface of the clamping area and the (lower) first surface of the optical recording medium. Therefore, the mentioned plane is a virtual plane below the first surface which is perpendicular to the axis A of the optical recording medium, and which is further defined by the lowest point(s) or lowest surface of the clamping area of the optical recording medium. As a result, the recording layer is arranged at a higher position (namely more than 0.9 mm with respect to the lowest surface of the clamping area) when the optical recording medium is clamped in a drive, whereas the recording layer of a known DVD is arranged at a position of about 0.6 mm with respect to the lowest surface of the clamping area.

According to a third aspect of the present invention, the optical recording medium has a clamping area with a thickness T₂ which is greater than the distance T₁ between the first surface and the second surface, wherein the recording layer is at least partially or entirely positioned at a distance T₈ of more than 0.4 mm from the first surface. Preferably, the increased thickness of the clamping area results in that the position of the recording layer is at a height of more than 0.9 mm with respect to the lowest surface of the clamping area.

### DESCRIPTION OF THE DRAWINGS

FIG. 1 shows a partial cross-sectional view of a known DVD-5;

FIG. 2 shows a partial cross-sectional view of a known DVD-9;

FIG. 3 shows a partial cross-sectional view of a known DVD-10;

FIG. 4 shows a partial cross-sectional view of a known CD;

FIGS. 5 and 6 show microscope pictures of a recording layer of a CD and of a DVD, respectively;

FIG. 7 shows a cross-sectional view of an optical recording medium according to a first embodiment of the present invention;

FIGS. 8a and 8b show a cross-sectional view of the optical recording medium according to a second embodiment of the present invention in its unclamped and its clamped state;

FIGS. 9a and 9b show a cross-sectional view of the optical recording medium according to a third embodiment of the present invention in its unclamped and its clamped state;

FIGS. 10a and 10b show a cross-sectional view of the optical recording medium according to a fourth embodiment of the present invention in its unclamped and its clamped state;

FIG. 11a shows a partial cross-sectional view of a known CD with a laser beam focused on the recording layer;

FIG. 11b shows a partial cross-sectional view of a known DVD with a laser beam focused on the recording layer;

FIG. 11c shows a partial cross-sectional view of an optical recording medium according to the first embodiment of the present invention with a laser beam focused on the recording layer;

FIG. 12 is a schematic drawing of a laser focusing mechanism and a photo diode for reading an optical recording medium; and

FIG. 13 shows a partial view of a clamping mechanism of a disc drive.

### DETAILED DESCRIPTION

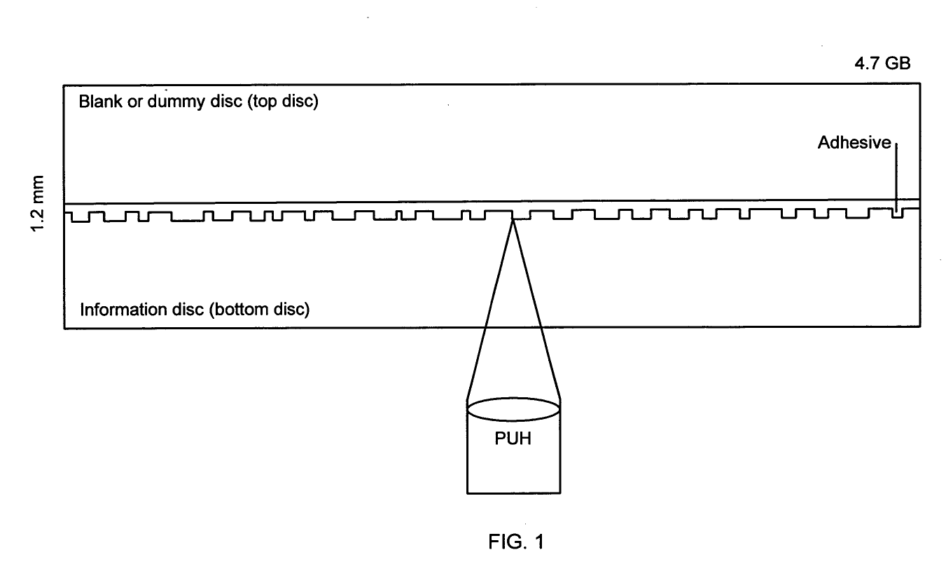

For a full understanding of the invention, the physical formats of DVDs and CDs according to the state of the art are discussed in the following. FIG. 1 shows a partial cross-sectional view of a known DVD-5. A DVD-5 comprises an information disc (bottom disc) 1 and a blank or dummy disc (top disc) 2 both made of polycarbonate and bonded together by a resin layer 4. The upper surface of the information disc is structured and carries a recording layer 3 made of aluminum. The recording layer 3 forms so-called pits and lands which correspond to the data stream stored on the DVD-5 (the total storage capacity of a DVD-5 is 4.7 GB). The total thickness of a DVD-5 is about 1.2 mm, wherein the thickness of the information disc 1 has a thickness of about 0.6 mm so that the recording layer 3 is positioned with a distance of about 0.6 mm from the outer surface of the information disc 1. For reading the data stream stored on the DVD-5, a laser beam 5 is focused on the recording layer 3.

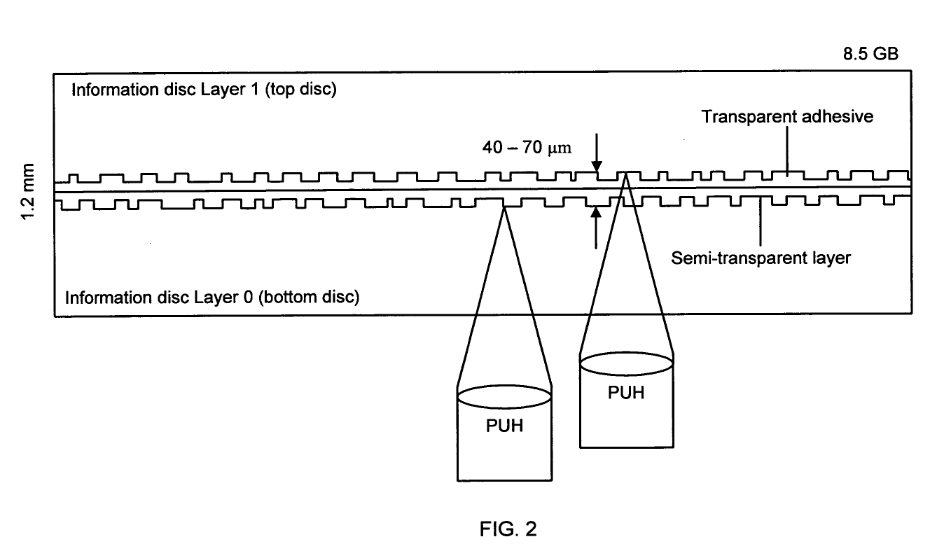

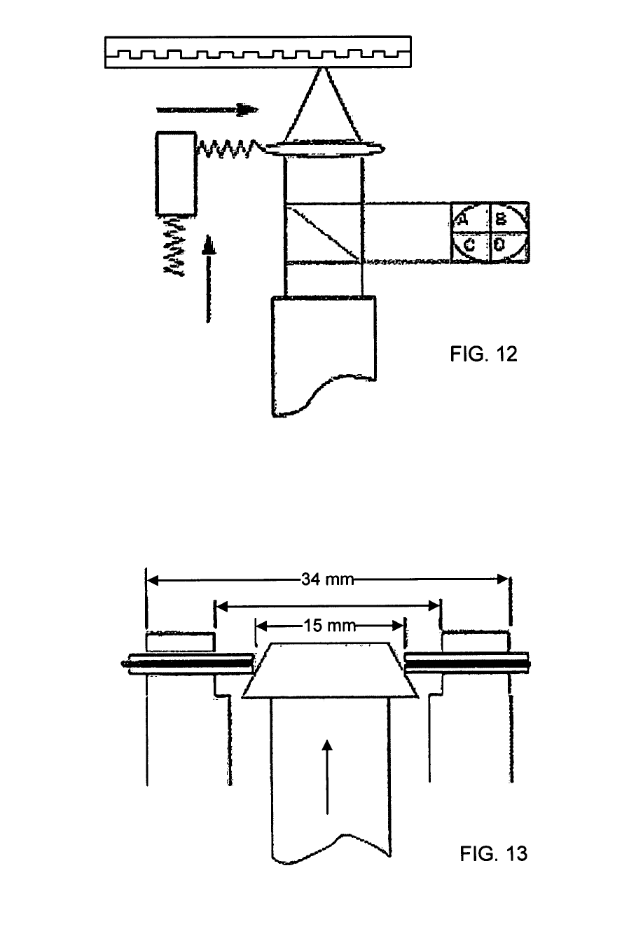

FIG. 2 shows a partial cross-sectional view of a known DVD-9 having a total storage capacity of 8.5 GB and a total thickness of also 1.2 mm. A DVD-9 has two information discs 1 and 1′ with two recording layers 3 and 3′. The first (lower) recording layer 3′ is semi-transparent so that the laser beam can alternatively be focused on the first (lower) or the second (upper) recording layer from the bottom side. For this purpose, a transparent adhesive is used for bonding the information discs together. Further, the laser beam system or the convection lens system of the laser is adjustable so that the focus of the laser beam is located on the desired recording layer. A schematic drawing of such a focusing mechanism 6 for a laser 7 is shown in FIG. 12. The laser beam is reflected by the recording layer and is then directed by a semi-permeable mirror to a photo diode 8.

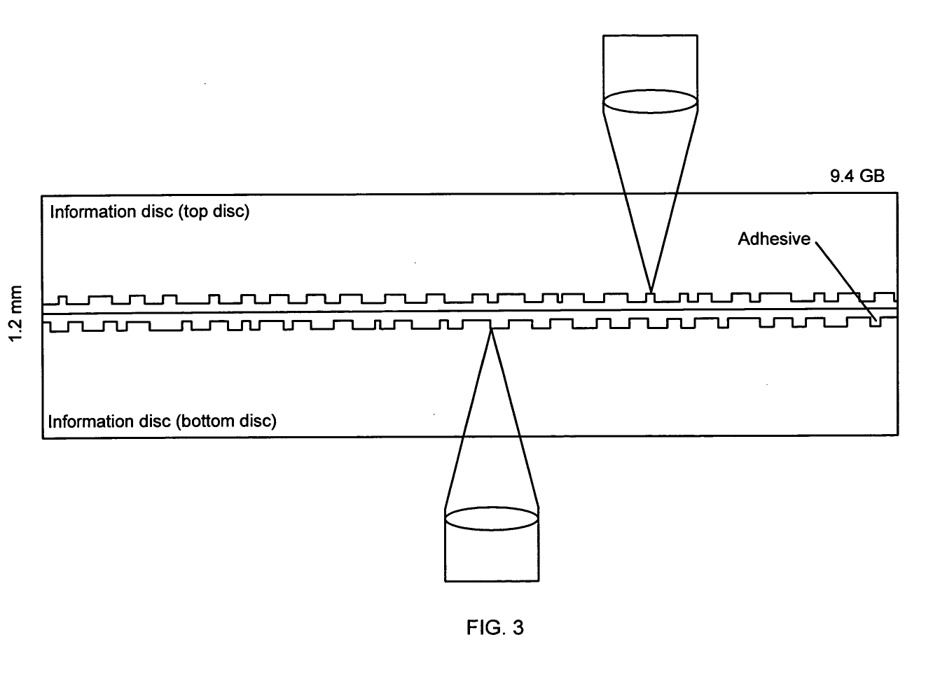

FIG. 3 shows a partial cross-sectional view of a known DVD-10 having a total storage capacity of 9.4 GB and a total thickness of also 1.2 mm. The physical format is similar to a DVD-9. However, the (second) upper recording layer 3′ is read by a second laser beam 5′ which is arranged on the side of the second (upper) information disc (opposed to the first laser beam 5).

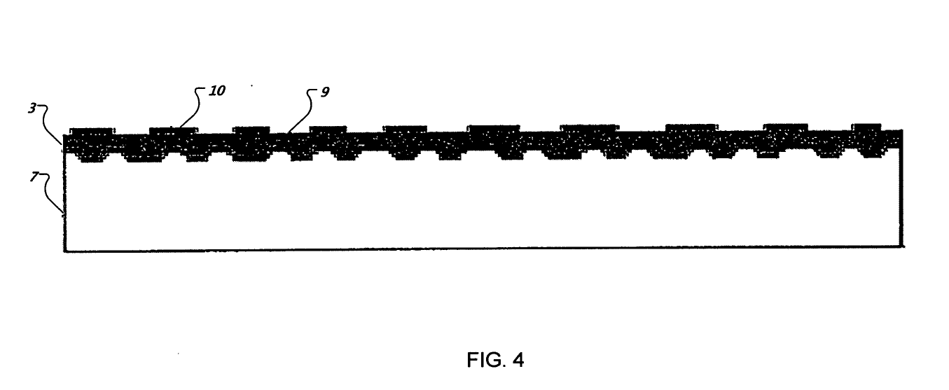

Finally, FIG. 4 shows a partial cross-sectional view of a known CD which only comprises one disc 1″ made of polycarbonate. The recording layer 3 is only covered by a protective lacquer 9 which usually carries a printed layer 10. The total thickness of a CD is again about 1.2 mm. However, the recording layer is not positioned in the center of the recording medium (between two discs), but at the top the recording medium. Therefore, the distance from the lower surface of the disc 1″ to the recording layer 3 is about 1.0 mm to about 1.15 mm. Since the CD is identically positioned within the drive like a DVD (in case of a combinational drive which is suitable for DVDs and CDs), the focusing mechanism 6 must be suitable to focus the laser beam to the height of the recording layer of the CD which is higher than the recording layer(s) of a DVD.

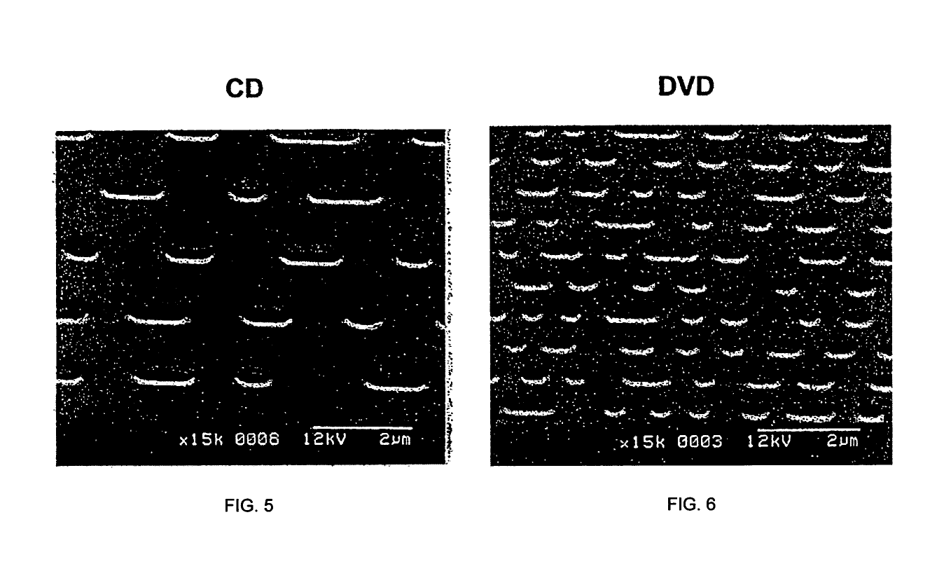

In this context, it has to be noted that a laser for reading a DVD has a wavelength of about 650 nm, and a laser for reading a CD has a wavelength of about 780 nm. Therefore, a combinational drive which is suitable for DVDs and CDs needs to have two lasers for providing these two wavelengths. The reason why different wavelengths are necessary is that the height difference between pits and lands of the recording layer are different for DVDs and for CDs. This height difference must be about λ/4, i.e. 650 nm/4 (+/−4%) for a DVD, and 780 nm/4 (+/−4%) for a CD. In addition, the pit and land structure of a DVD is significantly smaller compared to a CD, as can be seen in FIGS. 5 and 6 which show microscope pictures of a recording layer of a CD and of a DVD, respectively.

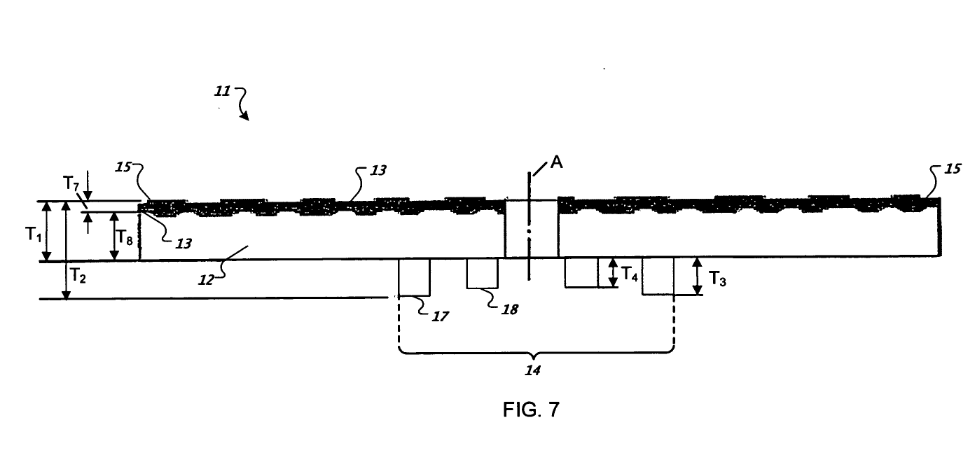

FIG. 7 shows a (schematic) cross-sectional view of an optical recording medium according to a first embodiment of the present invention. The optical recording medium comprises an information disc or a substrate 12 and a recording layer 13 arranged on one side of the substrate 12, wherein the optical recording medium has a predetermined clamping area 14. The recording layer 13 is covered by a lacquer layer 13′.

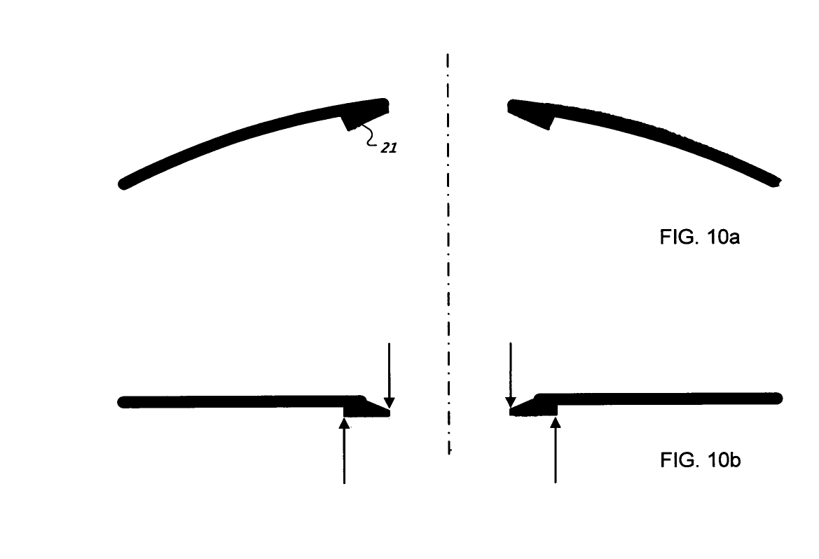

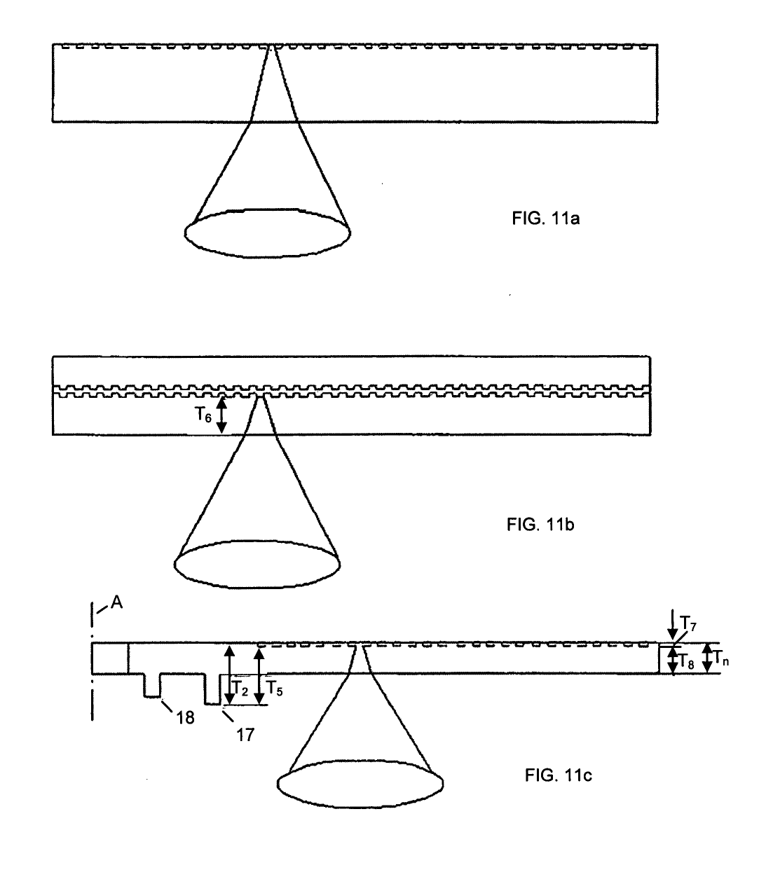

When the inventive optical recording is clamped in a drive, the recording layer has a different height compared to recording layers of known DVDs. As stated before, the recording layer(s) of a DVD according to the state of the art is/are arranged in its center (see also FIG. 11b showing a partial cross-sectional view of a known DVD with a laser beam focused on the recording layer). Contrary to that, the recording layer of a CD according to the state of the art is arranged at the top (see also FIG. 11a showing a partial cross-sectional view of a known DVD with a laser beam focused on the recording layer). According to the present invention, the DVD has a layer structure of a CD, i.e. the recording layer is arranged at the top of a DVD according to the present invention as shown in FIG. 11c. Such a layer arrangement is not known in the prior art, because laser beam of DVD drives is focused to a distance of T₆ (of about 0.6 mm) with respect to the lower surface of the disc, wherein the position of this lower surface is defined by the clamping mechanism. However, in case of the situation as shown in FIG. 11c, the distance T₅ of the lowest part of the disc to the recording layer is significantly greater than T₆, namely between 1.0 mm and 1.2 mm, in particular about 1.1 mm. Many commercially available drives which are only suitable for reading DVDs have no height adjustment mechanism as shown in FIG. 12. Therefore, a DVD shown in FIG. 11c can not be read with such DVD drives, because the recording layer is at a height of about 1.1 mm (and not 0.6 mm). Nevertheless, the inventive DVD shown in FIG. 11c can be read with a drive which is suitable for reading DVDs and CDs, because such drives have a height adjustment mechanism as shown in FIG. 12. As a result, the inventive DVD of FIG. 11c has a recording layer positioned at a height as the recording layer of a CD, and can only be read with a drive with a 650 nm laser which is or can be focused on this recording layer.

Besides the layer structure of the inventive optical recording medium, it is further advantageous for all embodiments of the present invention to provide the inventive optical recording medium with the following mechanical aspects:

Referring again to FIG. 7, the clamping area 14 is formed such as to achieve a deformation of or a tension in at least a part of the optical recording medium 11 when it is clamped within a recording and/or reproducing device. In particular, the deformation or tension is present in an area or in the entire area of the optical recording medium which is located outside of the clamping area 14. The deformation or tension preferably results in a change of the relative position of the outer edges 15 of the optical recording medium with respect to the clamping area. As a result, the optical recording medium may have a thinner thickness in the area of the recording layer (outside of the clamping area) of—for example—only about 0.6 mm or even less. In particular, the thickness T₁ of the optical recording medium in an area outside of the clamping area is in the range between 0.4 to 0.7 mm. However, it is to be understood that the invention is not limited to a specific thickness of the optical recording medium. Also a total thickness T₂ of the optical recording medium in the outer section of the clamping area 14 of about 1.2 mm is possible.

Trials in the prior art with optical recording discs having a reduced thickness in the area of the recording layer compared to common DVDs or CDs (having a thickness of about 1.2 mm) were not successful, because of the reduced stiffness and/or reduced shape stability of the discs. Therefore, the reliability of such disc was not satisfying (i.e. the discs could not be played on all types of players available on the market). However, with the optical recording medium according to the present invention, this drawback is significantly reduced or even completely avoided, because the stiffness is increased in the clamped state of the optical recording medium due to the deformation of or the tension in the medium. Thus, the inventive optical recording medium compensates the reduced stiffness of the thin recording medium by means of the deformation/tension. In the same manner, a thin sheet of paper which has a very low shape stability per se, may gain a significant stability if a tension is applied or if a deformation is applied (e.g. in the hand of a lecturer).

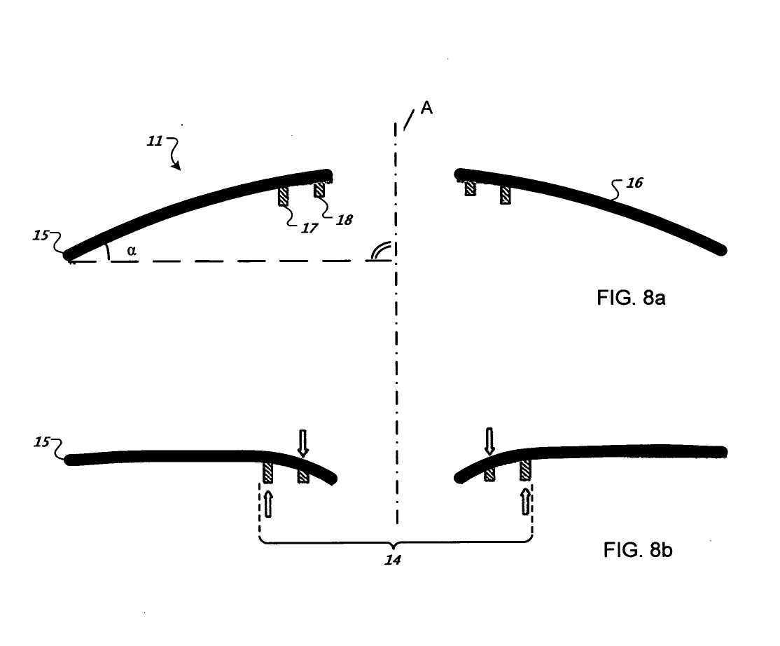

FIGS. 8a and 8b show a cross-sectional view of the optical recording medium according to a second embodiment of the present invention in its unclamped and its clamped state. According to this embodiment of the invention, the optical recording medium is a disk having the general shape of a cone or of an umbrella 16 when the optical recording medium is in an unclamped state, with an small angle α between a surface of the optical recording medium and a plane which is perpendicular to the axis A of the optical recording medium. The angle α is preferably greater than 0.5°, in particular in the range between 0.8° and 3°, when the disc is in an unclamped state (i.e., the schematic drawings in FIGS. 8a and 8b are exaggerating the angle dimension). In case of an umbrella shape (as shown), the mentioned angles are maximum angles which occur at the outer edges 15 of the disc. In the clamped stated of the disk, the angle α is reduced. A similar effect is given with the wings of a jumbo jet which are lifted when the jet is flying.

With this preferred embodiment of the invention, the deformation of or tension in the optical recording medium preferably results in that the optical recording medium adopts a generally flat shape, in particular if the optical recording medium is clamped in the clamping area by a force of 0.3 to 5 N, in particular by a force of 0.5 to 2.5 N.

From a structural point of view, the above effects can be achieved—as shown in FIGS. 7, 8a and 8b—by an optical recording medium which having a first ring 17 on a first side of the optical recording medium which extends at least in the outer section of the clamping area 14 of the optical recording medium. According to the present DVD/CD standard, the clamping area is defined by an area located within a radius of about 16 or 17 mm with respect to the axis of the optical recording medium (the diameter of the clamping area is less than about 34 mm, in particular less than about 28 mm). A typical clamping mechanism is—for example—shown in FIG. 13. Alternatively, the optical recording medium comprises one or more first protrusions on a first side of the optical recording medium located in the outer section of the clamping area 14 of the optical recording medium.

In order to limit the maximum deformation/tension in the disc, it is preferred to provide a second ring 18 on the first side of the optical recording medium which extends at least in the inner section of the clamping area 14 of the optical recording medium. Alternatively, the optical recording medium comprises one or more second protrusions on the first side of the optical recording medium located in the inner section of the clamping area 14 of the optical recording medium.

The first ring 17 has a thickness T₃ which is slightly greater than the thickness T₄ of the second ring 18. When both rings are pressed down to a flat surface of a clamping means, the (outer) first ring touches the surface first, and then—by increasing the clamping force—the (inner) second ring also touches the surface so that the inner edge of the optical recording medium is deformed downwardly with respect to the area at the (outer) first ring 17. This situation is shown in FIG. 8b. At the same time, the outer edges of the optical recording medium are lifted, because the (outer) first ring 17 acts like a jacking/bearing area. As a result, the conical/umbrella shape 16 of the optical recording medium may achieve an almost flat shape in its outer area (in particular in the area of the recording layer) with high shape stability.

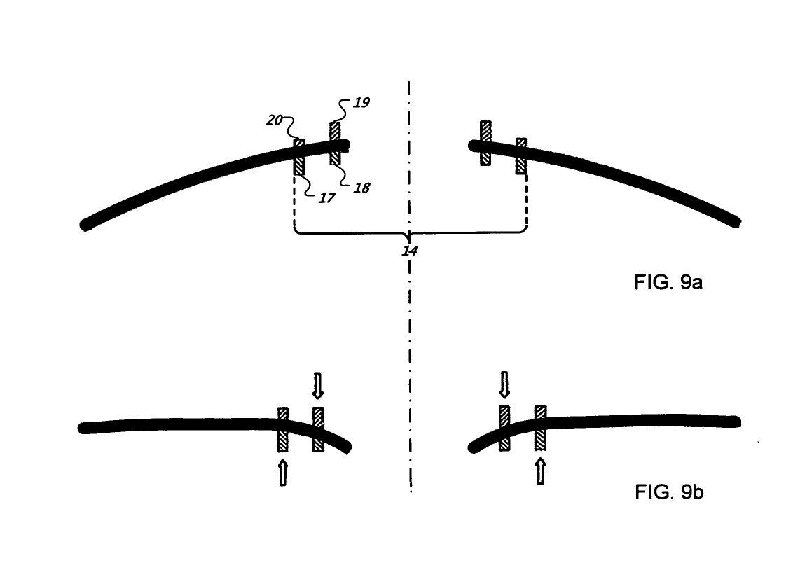

FIGS. 9a and 9b show a cross-sectional view of the optical recording medium according to a third embodiment of the present invention in its unclamped and its clamped state. The optical recording medium according to this embodiment has a third ring 19 on a second side of the optical recording medium which extends at least in the inner section of the clamping area 14 of the optical recording medium, as well as a fourth ring 20 on the second side of the optical recording medium which extends at least in the outer section of the clamping area 14 of the optical recording medium. Again, instead of the third ring and the fourth ring, third and fourth protrusions may be provided for achieving the same effect.

FIGS. 10a and 10b show a cross-sectional view of the optical recording medium according to a fourth embodiment of the present invention in its unclamped and its clamped state. In this embodiment, the jacking/bearing effect is achieved with a clamping area 14 having a conically shaped surface 21 on a first side of the optical recording medium such that the total thickness of the optical recording medium reduces from the outer section of the clamping area 14 to the inner section of the clamping area 14.

What is claimed is:

1. An optical recording medium comprising:
a substrate;
a recording layer arranged on one side of the substrate; and
a predetermined clamping area formed to achieve a deformation of at least a part of the optical recording medium when the optical recording medium is clamped within a device.

2. The optical recording medium of claim 1, wherein the deformation comprises a tension in the part of the optical recording medium.

3. The optical recording medium of claim 1, wherein the device comprises a recording or reproducing device.

4. The optical recording medium of claim 1, wherein the deformation is present in an area of the optical recording medium located outside of the clamping area.

5. The optical recording medium of claim 1, wherein the deformation is present in an entire area of the optical recording medium located outside of the clamping area.

6. The optical recording medium of claim 1, wherein the deformation changes a relative position of outer edges of the optical recording medium with respect to the clamping area.

7. The optical recording medium of claim 1, wherein the deformation of the optical recording medium results in the optical recording medium adopting a substantially flat shape when the optical recording medium is in a clamped state.

8. The optical recording medium of claim 8, wherein the optical recording medium adopts the substantially flat shape if the optical recording medium is clamped in the clamping area by a force in a range of 0.3 to 5 N, inclusive.

9. The optical recording medium of claim 1, further comprising a first ring on a first side of the optical recording medium that extends at least in an outer section of the clamping area of the optical recording medium.

10. The optical recording medium of claim 9, further comprising a second ring on the first side of the optical recording medium that extends at least in an inner section of the clamping area of the optical recording medium.

11. The optical recording medium of claim 10, wherein the first ring has a thickness that is substantially equal to or greater than a thickness of the second ring.

12. The optical recording medium of claim 10, further comprising a third ring on a second side of the optical recording medium that extends at least in the inner section of the clamping area of the optical recording medium.

13. The optical recording medium of claim 12, further comprising a fourth ring on the second side of the optical recording medium that extends at least in the outer section of the clamping area of the optical recording medium.

14. The optical recording medium of claim 1, further comprising one or more first protrusions on a first side of the optical recording medium located in an outer section of the clamping area of the optical recording medium.

15. The optical recording medium of claim 14, further comprising one or more second protrusions on the first side of the optical recording medium located in an inner section of the clamping area of the optical recording medium.

16. The optical recording medium of claim 15, wherein the first protrusions have a thickness that is substantially equal to or greater than a thickness of the second protrusions.

17. The optical recording medium of claim 15, further comprising one or more third protrusions on a second side of the optical recording medium located in the inner section of the clamping area of the optical recording medium.

18. The optical recording medium of claim 17, further comprising one or more fourth protrusions on the second side of the optical recording medium located in the outer section of the clamping area of the optical recording medium.

19. The optical recording medium of claim 1, wherein the clamping area has a conically shaped surface on a first side of the optical recording medium such that a thickness of the optical recording medium reduces from an outer section of the clamping area to an inner section of the clamping area.

20. The optical recording medium of claim 1, wherein the thickness of the optical recording medium in the outer section of the clamping area is substantially 1.2 mm.

21. The optical recording medium of claim 1, wherein the thickness of the optical recording medium in an area outside of the clamping area is within a range 0.4 to 0.7 mm, inclusive.

22. The optical recording medium of claim 1, wherein the clamping area comprises an area located within a radius of substantially 17 mm with respect to an axis of the optical recording medium.

23. The optical recording medium comprising:
a disc comprising
a substrate;
a recording layer arranged on one side of the substrate; and
a predetermined clamping area;
wherein the disc has a general shape of a cone when in an unclamped state, with an angle (α) between a surface of the disc and a plane that is perpendicular to an axis (A) of the disc.

24. The optical recording medium of claim 23, wherein the clamping area is formed such that the angle (α) is reduced when the disc is in a clamped state.

25. The optical recording medium of claim 23, wherein the angle (α) is greater than 0.5° when the disc is in an unclamped state.

26. The optical recording medium of claim 23, wherein the disc has an outer diameter of substantially 65 mm or substantially 120 mm.

27. The optical recording medium of claim 23, wherein the disc comprises a DVD readable with a laser beam having a wavelength of substantially 650 nm.

28. The optical recording medium of claim 23, wherein the disc comprises a CD readable with a laser beam having a wavelength of substantially 780 nm.

29. An optical recording medium comprising:
a substrate;
a recording layer arranged on one side of the substrate;
a predetermined clamping area; and
a first ring on a first side of the optical recording medium that extends at least in an outer section of the clamping area, wherein the first ring is configured to achieve a deformation of at least a part of the optical recording medium outside the clamping area when the optical recording medium is clamped within a device.

30. An optical recording medium comprising:
a substrate;
a recording layer arranged on one side of the substrate;
a predetermined clamping area; and
one or more first protrusions on a first side of the optical recording medium located in an outer section of the clamping area, wherein the one or more first protrusions are configured to achieve a deformation of at least a part of the optical recording medium outside the clamping area when the optical recording medium is clamped within a device.
